(19) United States
(12) Patent Application Publication
(10) Pub. No.: US 2019/0006699 A1
(43) Pub. Date: Jan. 3, 2019

(54) PRESSURE AND/OR TEMPERATURE MANAGEMENT IN ELECTROCHEMICAL SYSTEMS

(71) Applicant: Sion Power Corporation, Tucson, AZ (US)

(72) Inventors: Lowell D. Jones, Tucson, AZ (US); Ernie Botos, Vail, AZ (US); Clellie Winter, Tucson, AZ (US)

(73) Assignee: Sion Power Corporation, Tucson, AZ (US)

(21) Appl. No.: 15/727,438

(22) Filed: Oct. 6, 2017

Related U.S. Application Data
(63) Continuation of application No. 14/157,329, filed on Jan. 16, 2014, now abandoned.
(60) Provisional application No. 61/753,063, filed on Jan. 16, 2013.

(51) Int. Cl. H01M 10/04; H01M 10/0525; H01M 10/613; H01M 10/647; H01M 10/6557; H01M 10/6563; H01M 10/6567; H01M 4/38; H01M 4/40; H01M 10/643

(52) U.S. Cl. CPC H01M 10/0481; H01M 10/0525; H01M 10/613; H01M 10/647; H01M 10/643; H01M 10/6563; H01M 10/6567; H01M 4/382; H01M 4/405; H01M 10/6557

(57) ABSTRACT

Systems and methods for the application of force to and thermal management of electrochemical cells are generally described. In some embodiments, a pressure distributor containing a fluid is configured such that a force can be applied to at least one component of an electrochemical cell (e.g., an active surface of an electrode within the electrochemical cell) through the pressure distributor. In certain embodiments, a pressure transmitter can be configured to apply the force to a component of the electrochemical cell through the pressure distributor. The fluid within the pressure distributor can ensure that the anisotropic force applied to the electrochemical cell is distributed substantially evenly over the interface between the pressure distributor and a component of the electrochemical cell and therefore, over the active surface of one or more electrodes within the electrochemical cell. In some embodiments, the fluid within the pressure distributor can also be used to transfer heat to and/or from the electrochemical cell, such as heat that is generated during charge and/or discharge of the electrochemical cell.

### RELATED APPLICATIONS

This application is a continuation of U.S. application Ser. No. 14/157,329, filed Jan. 16, 2014, and entitled “Pressure and/or Temperature Management in Electrochemical Systems,” which claims priority to U.S. Provisional Application No. 61/753,063, filed Jan. 16, 2013, and entitled “Pressure and/or Temperature Management in Electrochemical Systems,” each of which is incorporated herein by reference in its entirety for all purposes.

### GOVERNMENT SPONSORSHIP

This invention was made with Government support under Grant No. DE-AR0000067, awarded by the Department of Energy ARPA-E program (ARPA-E BEEST DE-FOA-00000207-1536). The Government has certain rights in this invention.

### FIELD OF INVENTION

Systems and methods involving the application of force to and thermal management of electrochemical systems are generally described.

### BACKGROUND

Electrochemical cells store energy by separating an ion source and an ion sink at differing electrochemical potential. A typical electrochemical cell has a cathode and an anode which participate in an electrochemical reaction to produce power. Some electrochemical cells (e.g., rechargeable electrochemical cells) may undergo a charge/discharge cycle involving stripping and deposition of metal (e.g., lithium metal) on the surface of the anode accompanied by parasitic reactions of the metal on the anode surface with other cell components (e.g., electrolyte components), wherein the metal can diffuse from the anode surface during discharge. The efficiency and uniformity of such processes can affect the function of the electrochemical cell. In some cases, one or more surfaces of one or more electrodes may become uneven as the electrochemical cell undergoes repeated charge/discharge cycles, often due to uneven redeposition of an ion dissolved in the electrolyte. The roughening of one or more surfaces of one or more electrodes can result in increasingly poor cell performance. Accordingly, electrochemical cells configured to address this issue would be desirable.

### SUMMARY OF THE INVENTION

The application of force to and the thermal management of electrochemical cells are generally described. The subject matter of the present invention involves, in some cases, interrelated products, alternative solutions to a particular problem, and/or a plurality of different uses of one or more systems and/or articles.

In one aspect, an electrochemical system is provided. The electrochemical system comprises, in certain embodiments, an electrochemical cell; a pressure distributor containing a fluid, the pressure distributor associated with the electrochemical cell; and a pressure transmitter positioned to apply an anisotropic force to at least one component of the electrochemical cell through the pressure distributor.

In some embodiments, the electrochemical system comprises an electrochemical cell comprising an electrode; a pressure distributor containing a fluid; and a pressure transmitter positioned to apply an anisotropic force to the pressure distributor, whereby an anisotropic force is applied to a surface of the electrode.

In another aspect, a method of applying an anisotropic force to an electrochemical cell is provided. The method comprises, in certain embodiments, applying a force to a fluid-containing pressure distributor such that an anisotropic force is applied to at least one component of the electrochemical cell through the pressure distributor.

In certain embodiments, a method of applying a force to an electrochemical cell to enhance cell performance is provided. The method comprises, in certain embodiments, applying an anisotropic force through a fluid within a pressure distributor to at least a portion of an electrochemical cell during use of the cell, wherein an electrode of the electrochemical cell comprises a metal, and the force is sufficiently large such that application of the force affects the surface morphology of the metal within the electrode.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIGS. 1A-1D are cross-sectional schematic diagrams illustrating the application of an anisotropic force to one or more electrochemical cells, according to some embodiments;

FIG. 2A-2C are, according to certain embodiments, cross-sectional schematic illustrations of systems in which fluid is transported through a pressure distributor for thermal control; and

FIGS. 3A-3C are exemplary cross-sectional schematic illustrations of electrochemical cells, according to certain embodiments.

### DETAILED DESCRIPTION

Systems and methods for the application of force to and thermal management of electrochemical cells are generally described. In some embodiments, a pressure distributor containing a fluid is configured such that a force can be applied to at least one component of an electrochemical cell (e.g., an active surface of an electrode within the electrochemical cell) through the pressure distributor. In certain embodiments, a pressure transmitter can be configured to apply the force to a component of the electrochemical cell through the pressure distributor. The fluid within the pressure distributor can ensure that the anisotropic force applied to the electrochemical cell is distributed substantially evenly over the interface between the pressure distributor and an adjacent component and therefore, over the active surface of one or more electrodes within the electrochemical cell. In some embodiments, the fluid within the pressure distributor can also be used to transfer heat to and/or from the electrochemical cell, such as heat that is generated during charge and/or discharge of the electrochemical cell.

U.S. Patent Publication No. 2010/0035128 to Scordilis-Kelley et al. filed on Aug. 4, 2009, entitled “Application of Force in Electrochemical Cells,” (which is incorporated herein by reference in its entirety for all purposes) describes the application of force in electrochemical cells for improved electrode chemistry, morphology, and/or other characteristics indicative of improved cell performance. Electrochemical cell performance can be enhanced, for example, by applying an anisotropic force with a component normal to an active surface of an electrode (e.g., an anode such as an elemental lithium anode) of the electrochemical cell. For example, some electrochemical cells (e.g., rechargeable electrochemical cells) undergo a charge/discharge cycle involving deposition of metal (e.g., lithium metal or other active material) on a surface of an electrode (e.g., anode) upon charging and reaction of the metal on the electrode surface, wherein the metal diffuses from the anode surface, upon discharging. The uniformity with which the metal is deposited in such cells may affect cell performance. As one particular example, when lithium metal is removed from and/or redeposited on an anode, it may, in some cases, result in an uneven surface; for example, upon redeposition, lithium may deposit unevenly forming a rough surface. The roughened surface may increase the amount of lithium metal available for undesired chemical reactions which may result in decreased cycling lifetime and/or poor cell performance. The application of an anisotropic force with a component normal to an electrode active surface within the electrochemical cell has been found to reduce such behavior and to improve the cycling lifetime and/or performance of the cell.

However, in many cases in which an anisotropic force with a component normal to an electrode active surface is applied to an electrochemical cell, the force is distributed unevenly across the electrode active surface. For example, if the electrochemical cell or an associated containment structure is not completely flat, the force applied by a pressure plate, spring, or other force-imparting component may vary across the surface on which the force is applied. As another example, opposing sides of an electrochemical cell may not be perfectly parallel in some cases, leading to variations in the applied force across the cell surface. Even in cases where a soft rubber or other conforming material is positioned between the electrochemical cell and a force-imparting component, uneven pressure distribution is often observed.

The present invention involves, in one set of embodiments, the recognition that the beneficial effects of applying an isotropic force to an electrochemical cell can be enhanced by employing a pressure distributor containing a fluid. The pressure distributor can be associated with an electrochemical cell and configured such that an anisotropic force can be applied to a component of the electrochemical cell (e.g., an electrode of the electrochemical cell) through the pressure distributor (e.g., via a pressure transmitter such as a plate, spring, or other device). The fluid within the pressure distributor can distribute the applied anisotropic force(s) substantially evenly over the interface between the pressure distributor and an adjacent component and therefore, substantially evenly over the active surface of one or more electrodes within the cell. When the anisotropic force is applied substantially evenly over the active surface of an electrode(s), roughening can be reduced or eliminated across part or all of the electrode surface.

The present invention also involves, in some embodiments, the recognition that when fluids are employed to distribute an applied force evenly across an electrochemical cell, heat transfer to and/or away from the cell can be enhanced via strategic transport of the fluid. For example, in some embodiments, a pressure distributor can include an inlet and/or an outlet which can allow one to flow a fluid into and/or out of the pressure distributor. Flowing fluid into and/or out of the pressure distributor can allow for convective transfer of heat away from the electrochemical cell and/or another component of the system. Flowing fluid into and/or out of the pressure distributor can also allow for convective transfer of heat to the electrochemical cell and/or another component of the system.

In some embodiments, the force applied to the electrochemical cell through the pressure distributor is an anisotropic force. An “anisotropic force” is given its ordinary meaning in the art and means a force that is not equal in all directions. A force equal in all directions is, for example, internal pressure of a fluid or material within the fluid or material, such as internal gas pressure of an object. Examples of forces not equal in all directions include forces directed in a particular direction, such as the force on a table applied by an object on the table via gravity. Another example of an anisotropic force includes a force applied by a band arranged around a perimeter of an object. For example, a rubber band or turnbuckle can apply forces around a perimeter of an object around which it is wrapped. However, the band may not apply any direct force on any part of the exterior surface of the object not in contact with the band. In addition, when the band is expanded along a first axis to a greater extent than a second axis, the band can apply a larger force in the direction parallel to the first axis than the force applied parallel to the second axis.

In certain embodiments, the force applied to the electrochemical cell includes a component normal to a surface on or within the electrochemical cell (e.g., a component normal to an active surface of an electrode within the cell, as described further below). A force with a “component normal” to a surface (e.g., an active surface of an electrode such as an anode), is given its ordinary meaning as would be understood by those of ordinary skill in the art and includes, for example, a force which at least in part exerts itself in a direction substantially perpendicular to the surface. For example, in the case of a horizontal table with an object resting on the table and affected only by gravity, the object exerts a force essentially completely normal to the surface of the table. If the object is also urged laterally across the horizontal table surface, then it exerts a force on the table which, while not completely perpendicular to the horizontal surface, includes a component normal to the table surface. Those of ordinary skill can understand other examples of these terms, especially as applied within the description of this document.

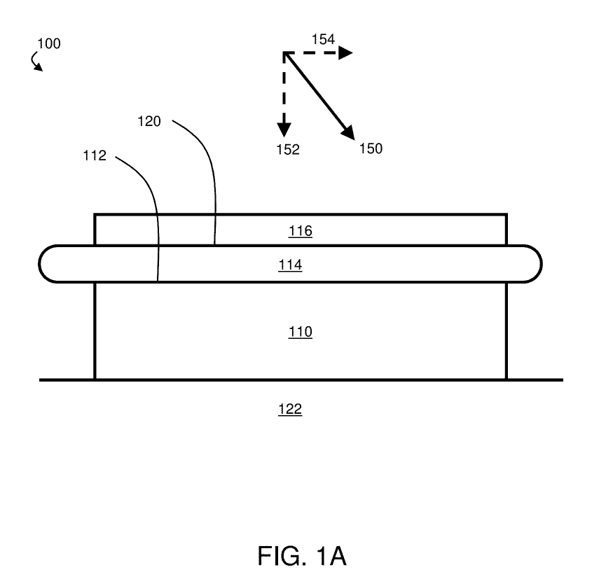

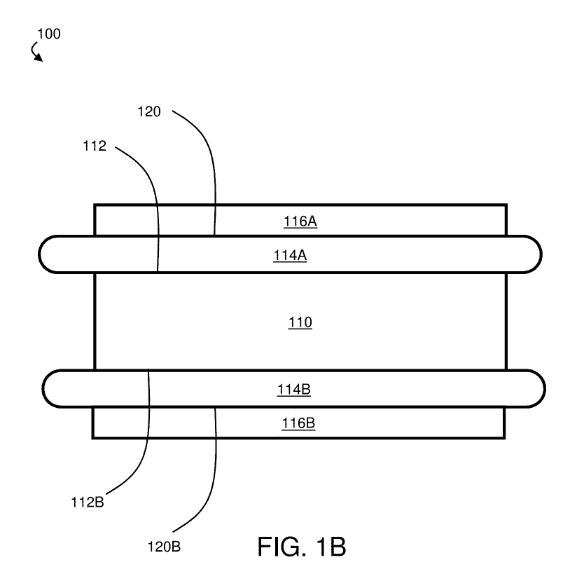

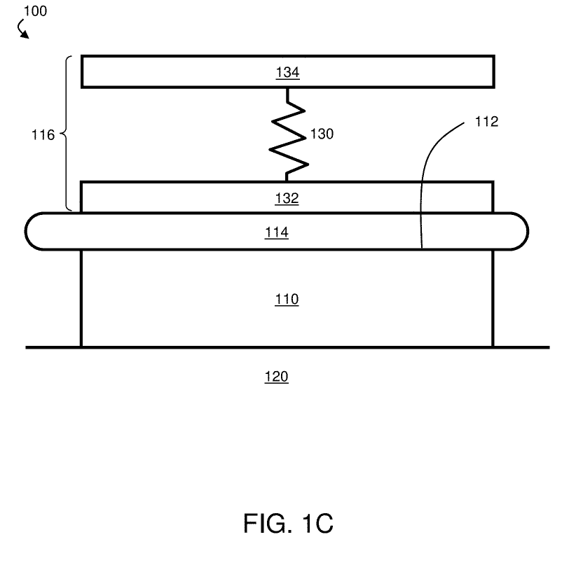

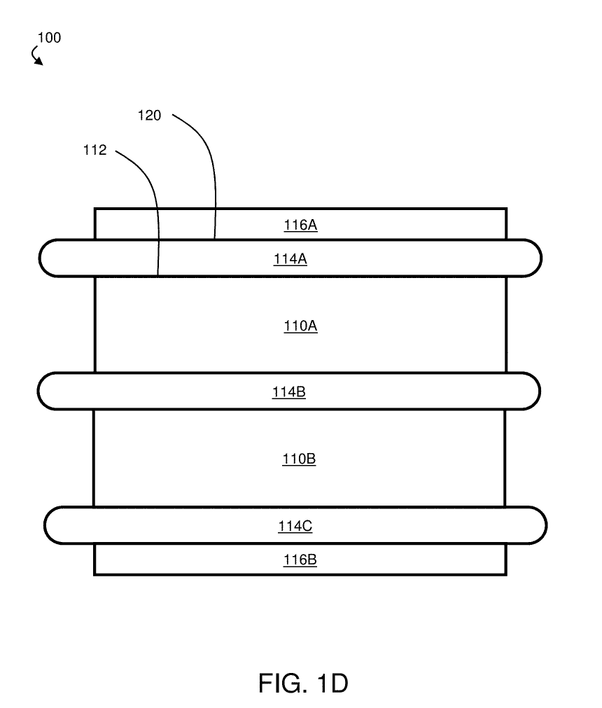

FIG. 1A is an exemplary cross-sectional schematic illustration of an electrochemical system 100 in which an anisotropic force is applied to an electrochemical cell 110, according to one set of embodiments. The term “electrochemical cell” is used herein to generally refer to an anode, a cathode, and an electrolyte configured to participate in an electrochemical reaction to produce power. An electrochemical cell can be rechargeable or non-rechargeable.

In FIG. 1A, system 100 includes electrochemical cell 110 and a pressure distributor 114 containing a fluid associated with electrochemical cell 110. Pressure distributor 114 can be configured such that an anisotropic force is applied to a component of electrochemical cell 110 through pressure distributor 114. For example, in the set of embodiments illustrated in FIG. 1A, pressure transmitter 116 can be configured to apply an anisotropic force to pressure distributor 114, which in turn causes an anisotropic force to be applied to at least one component (e.g., an electrode) of electrochemical cell 110. System 100 can also include a substrate 122 on which the electrochemical cell is positioned. Substrate 122 can comprise, for example, a tabletop, a surface of a container in which electrochemical cell 110 is housed, or any other suitable surface.

Pressure distributor 114 can be associated with electrochemical cell 110 in a variety of suitable configurations to produce the inventive systems and methods described herein. As used herein, a pressure distributor is associated with an electrochemical cell when at least a portion of a force that is applied to and/or through the pressure distributor can be transmitted to a component of the electrochemical cell. For example, in certain embodiments, a pressure distributor is associated with an electrochemical cell when the pressure distributor is in direct contact with the electrochemical cell or a component thereof. Generally, a first article and a second article are in direct contact when the first article and the second article are directly touching. For example, in FIG. 1A, pressure distributor 114 and the electrochemical cell 110 are in direct contact.

In certain embodiments, a pressure distributor is associated with electrochemical cell when the pressure distributor is in indirect contact with at least one component of the electrochemical cell. Generally, a first article and a second article are in indirect contact when a pathway can be traced between the first article and the second article that intersects only solid and/or liquid components. Such pathway can be in the form of a substantially straight line, in certain embodiments. A pressure distributor can be in indirect contact with an electrochemical cell, in certain embodiments, when one or more solid and/or liquid materials are positioned between them, but a force can still be transmitted to the electrochemical cell through the pressure distributor.

In certain embodiments, a pressure distributor is associated with an electrochemical cell when it is located within the boundaries of a container at least partially (e.g., completely) enclosing the components of the electrochemical cell. For example, in certain embodiments, pressure distributor 114 could be positioned between an electrode and a container at least partially enclosing the electrochemical cell. In certain embodiments, pressure distributor 114 could be positioned between a current collector and a container at least partially enclosing the electrochemical cell. In some embodiments, pressure distributor 114 can be used as a current collector, for example, positioned next to an electrode of the electrochemical cell and within a container at least partially containing the electrodes and electrolyte of the electric cell. This could be achieved, for example, by fabricating pressure distributor 114 from a material (e.g., a metal such as a metal foil, a conductive polymer, and the like) that is sufficiently electrically conductive to transport electrons to and/or from an electrode of the electrochemical cell.

In some embodiments, a pressure distributor is associated with an electrochemical cell when it is located outside the boundaries of a container at least partially (e.g., completely) enclosing the components of the electrochemical cell. For example, in certain embodiments, pressure distributor 114 could be positioned in direct or indirect contact with an exterior surface of a container at least partially enclosing the electrodes and electrolyte of an electrochemical cell.

In certain embodiments, the pressure distributor can be located a relatively short distance from at least one electrode of an electrochemical cell. For example, in certain embodiments, the shortest distance between the pressure distributor and an electrode of the electrochemical cell is less than about 10 times, less than about 5 times, less than about 2 times, less than about 1 time, less than about 0.5 times, or less than about 0.25 times the maximum cross-sectional dimension of that electrode.

In some embodiments, a pressure distributor can be associated with a particular electrode (e.g., an anode) of an electrochemical cell. For example, a pressure distributor can be in direct or indirect contact with an electrode (e.g., an anode such as an anode comprising lithium) of an electrochemical cell. In certain embodiments, the pressure distributor can be positioned outside a container at least partially containing the electrode but still associated with the electrode, for example, when only liquid and/or solid components separate the electrode from the pressure distributor. For example, in certain embodiments in which the pressure distributor is positioned in direct or indirect contact with a container at least partially enclosing the electrode and a liquid electrolyte, the pressure distributor would be associated with the electrode.

In certain embodiments, a force can be applied to electrochemical cell 110 or a component of electrochemical cell 110 (e.g., an electrode of the electrochemical cell) through pressure distributor 114. As used herein, a force is applied to a first component (e.g., an electrochemical cell) through a second component (e.g., a pressure distributor) when the second component at least partially transmits a force from the source of the force to the first component.

A force can be applied to an electrochemical cell or a component thereof through a pressure distributor in a variety of ways. In certain embodiments, applying a force to a pressure distributor comprises applying a force to an external surface of the pressure distributor. This can be achieved, for example, via pressure transmitter 116. For example, in FIG. 1A, pressure transmitter 116 can be positioned to apply an anisotropic force to electrochemical cell 110 through pressure distributor 114 by applying a force to surface 120 of pressure distributor 114. As used herein, a first component is positioned to apply an anisotropic force to a second component when the first and second components are positioned such that at least a portion of a force that is applied to and/or through the first component can be transmitted to the second component. In certain embodiments, pressure transmitter and the pressure distributor are in direct contact. In some embodiments, one or more materials (e.g., one or more solid and/or liquid materials) are positioned between the pressure transmitter and the pressure distributor, but a force can still be applied to the pressure distributor by the pressure transmitter. In certain embodiments, the pressure transmitter and the pressure distributor can be in indirect contact such that a continuous pathway can be traced through solid and/or liquid materials from the pressure distributor to the electrochemical cell. Such pathway can be substantially (e.g., completely) straight, in certain embodiments.

In the set of embodiments illustrated in FIG. 1A, pressure transmitter 116 and electrochemical cell 110 are positioned on opposite sides of pressure distributor 114. Accordingly, when an anisotropic force (e.g., an anisotropic force in the direction of arrow 150) is applied to and/or by pressure transmitter 116 to surface 120, the force can be transmitted through pressure distributor 114 onto surface 112 of electrochemical cell 110, and to the components of electrochemical cell 110.

In some embodiments, applying a force to a pressure distributor comprises applying a force to an internal surface of the pressure distributor. For example, in certain embodiments, a force can be applied through the pressure distributor to the electrochemical cell by maintaining and/or increasing the pressure of the fluid within the pressure distributor. In the set of embodiments illustrated in FIG. 1A, a force can be applied through pressure distributor 114 to electrochemical cell 110 by transporting additional fluid through an inlet (not shown) of pressure distributor 114 (e.g., by inflating pressure distributor 114). In some such embodiments, when the pressure within a pressure distributor is maintained and/or increased, the movement of pressure transmitter can be restricted such that a force is produced on an external surface of the electrochemical cell and/or on a component of the electrochemical cell (e.g., an active surface of an electrode within the electrochemical cell). For example, in FIG. 1A, as additional fluid is added to pressure distributor 114, pressure transmitter 116 can be configured to restrict the movement of the boundaries of pressure distributor 114 such that a force is applied to surface 112 of electrochemical cell 110.

In certain embodiments, fluid can be added to pressure distributor 114 before it is positioned between electrochemical cell 110 and pressure transmitter 116. After the fluid has been added, pressure distributor 114 can be compressed and positioned between electrochemical cell 110 and pressure transmitter 116, after which, the compression of the fluid within pressure distributor 114 can produce a force that is applied to surface 112 of electrochemical cell 110 (and, accordingly, to a surface of one or more components of the electrochemical cell, such as an active surface of an electrode). One of ordinary skill in the art, given the present disclosure, would be capable of designing additional systems and methods by which a force can be applied to an electrochemical cell through a pressure distributor.

The fluid within pressure distributor 114 can allow the pressure that is transmitted through pressure distributor 114 to be applied relatively evenly across the surface 112 of electrochemical cell 110 (and, accordingly, relatively evenly across a surface of one or more components of the electrochemical cell, such as an active surface of an electrode). Not wishing to be bound by any particular theory, it is believed that a presence of a fluid within pressure distributor 114 reduces and/or eliminates points of relatively high pressure on surface 112 as fluid within relatively high pressure regions is transported to regions of relatively low pressure.

In some embodiments, the degree to which the pressure distributor evenly distributes the force applied to electrochemical cell can be enhanced if the external surface of the pressure transmitter is appropriately aligned with an external surface of the electrochemical cell or a container thereof. For example, in the set of embodiments illustrated in FIG. 1A, external surface 120 of pressure transmitter 116 faces external surface 112 of electrochemical cell 110. In certain embodiments, the external surface of the pressure transmitter is substantially parallel to the external surface of the electrochemical cell to which a force is applied. For example, in the set of embodiments illustrated in FIG. 1A, external surface 120 of pressure transmitter 116 is substantially parallel to external surface 112 of electrochemical cell 110. As used herein, two surfaces are substantially parallel to each other when the two surfaces form angles of no greater than about 10 degrees. In certain embodiments, two substantially parallel surfaces form angles of no greater than about 5 degrees, no greater than about 3 degrees, no greater than about 1 degree, or no greater than about 0.1 degree.

The pressure distributor can have a variety of suitable forms. In certain embodiments, the pressure distributor can comprise a bag or other suitable container in which a fluid is contained. In some embodiments, the pressure distributor can comprise a bellows that is configured to deform along the direction in which the force is applied to the pressure distributor.

The pressure distributor container can be made of a variety of materials. In certain embodiments, the pressure distributor container can comprise a flexible material. For example, in certain embodiments, the pressure distributor container can comprise a polymer such as polyethylene (e.g., linear low density and/or ultra-low density polyethylene), polypropylene, polyvinylchloride, polyvinyldichloride, polyvinylidene chloride, ethylene vinyl acetate, polycarbonate, polymethacrylate, polyvinyl alcohol, nylon, silicone rubber (e.g., polydimethylsiloxane), and/or other natural or synthetic rubbers or plastics. In certain embodiments (e.g., in embodiments in which a gas is used as the fluid within the pressure distributor), the pressure distributor container can include a metal layer (e.g., an aluminum metal layer), which can enhance the degree to which fluid (e.g., a gas) is retained within the pressure distributor. The use of flexible materials can be advantageous, in certain embodiments, as they may allow for redistribution of the contents of the pressure distributor relatively easily, enhancing the degree to which the force is uniformly applied.

In some embodiments, the pressure distributor can comprise an elastic material. In certain embodiments, the elasticity of the material from which the pressure distributor is fabricated can be selected such that the pressure distributor transmits a desirable amount of a force applied to the pressure distributor to an adjacent component. To illustrate, in certain cases, if the pressure distributor is made of a very flexible material, a relatively high percentage of the force applied to the pressure distributor might be used to elastically deform the pressure distributor material, rather than being transmitted to an adjacent electrochemical cell. In certain embodiments, the pressure distributor can be formed of a material having a Young's modulus of less than about 1 GPa. One of ordinary skill in the art would be capable of measuring the Young's modulus of a given material by performing, for example, a tensile test (also sometimes referred to a tension test). Exemplary elastic polymers (i.e., elastomers) that could be used include the general classes of silicone polymers, epoxy polymers, and acrylate polymers.

In certain embodiments, the pressure distributor comprises an enclosed container containing a fluid. The pressure distributor can comprise an open container containing a fluid, in certain embodiments. For example, in some embodiments, the pressure distributor comprises a container fluidically connected to a device constructed and arranged to transport the fluid through the pressure distributor, as described in more detail below.

A variety of fluids can be used in association with the pressure distributor. As used herein, a “fluid” generally refers to a substance that tends to flow and to conform to the outline of its container. Examples of fluids include liquids, gases, gels, viscoelastic fluids, solutions, suspensions, fluidized particulates, and the like. Typically, fluids are materials that are unable to withstand a static shear stress, and when a shear stress is applied, the fluid experiences a continuing and permanent distortion. The fluid may have any suitable viscosity that permits flow and redistribution of an applied force.

In certain embodiments, the fluid within the pressure distributor comprises a gas (e.g., air, nitrogen, a noble gas (e.g., helium, neon, argon, krypton, xenon), a gas refrigerant, or mixtures of these). In certain embodiments, the gas within the pressure distributor can comprise a relatively high molecular weight (e.g., at least about 100 g/mol), which can limit the degree to which gas permeates through the walls of the pressure distributor. In some embodiments, the fluid within the pressure distributor comprises a liquid including, but not limited to, water, an electrolyte (e.g., a liquid electrolyte similar or identical to that used in the electrochemical cell), greases (e.g., petroleum jelly, Teflon grease, silicone grease), oils (e.g., mineral oil), and the like. In certain embodiments, the fluid within the pressure distributor comprises a gel. Suitable gels for use within the pressure distributor include, but are not limited to, hydrogels (e.g., silicone gel), organogels, or xerogels. In certain embodiments, the fluid comprises a fluidized bed of solid particles (e.g., sand, powders, and the like). Fluidization can be achieved, for example, by passing a gas and/or a liquid through the particles and/or by vibrating a substrate on which the particles are positioned such that the particles move relative to each other.

The fluid used in association with the pressure distributor can have any suitable viscosity. In certain embodiments, a Newtonian fluid can be used within the pressure distributor, although the invention is not so limited, and non-Newtonian fluids (e.g., a shear thinning fluid, a shear thickening fluid, etc.) can also be used. In certain embodiments, the pressure distributor can contain a Newtonian fluid with a steady-state shear viscosity of less than about 1×10⁷ centipoise (cP), less than about 1×10⁶ cP, less than about 1×10⁵ cP less than about 1000 cP, less than about 100 cP, less than about 10 cP, or less than about 1 cP (and, in some embodiments, greater than about 0.001 cP, greater than about 0.01 cP, or greater than about 0.1 cP) at room temperature.

In certain embodiments, the fluid within the pressure distributor can be selected such that it is suitable for being transported into and/or out of the pressure distributor. For example, in certain embodiments, fluid may be transported into the pressure distributor to apply an anisotropic force to the electrochemical cell (e.g., by compressing the fluid within the pressure distributor when it is positioned between the electrochemical cell and the pressure transmitter). As another example, a fluid may be transported into and/or out of a pressure distributor to transfer heat to and/or away from a component of the system.

Pressure transmitter 116 can also adopt a variety of configurations. In certain embodiments, pressure transmitter 116 is moveable relative to electrochemical cell 110. In some such embodiments, a force can be applied to electrochemical cell 110 through pressure distributor 114 by moving pressure transmitter 116 closer to electrochemical cell 110 and/or maintaining the separation between electrochemical cell 110 and pressure transmitter 116. As one particular example, FIG. 1C is a schematic illustration of a set of embodiments in which pressure transmitter 116 includes a compression spring 130, a first applicator structure 132, and a second applicator structure 134. First applicator structure 132 can correspond to, for example, a flat plate of rigid material, or any other suitable structure. Second applicator structure can correspond to, for example, a second plate of rigid material, a portion of a wall of a container in which the electrochemical cell is housed, or any other suitable structure. In FIG. 1C, a force can be applied to surface 112 of electrochemical cell 110 when compression spring 130 is compressed between applicator structure 132 and applicator structure 134. The force can be applied to electrochemical cell 110 by moving structure 134 closer to electrochemical cell 110 and/or by maintaining the separation between structure 134 and electrochemical cell 110 when spring 130 is under compression. In certain embodiments, another force-generating component can be positioned over structure 132, in place of, or in addition to, spring 130. For example, in certain embodiments, Belleville washers, machine screws, pneumatic devices, weights, air cylinders, and/or hydraulic cylinders could be used in place of, or in addition to, compression spring 130. In some embodiments, a force can be applied to an electrochemical cell using a constricting element (e.g., an elastic band, a turnbuckle band, etc.) arranged around one or more external surfaces of the electrochemical cell. A variety of suitable methods for applying a force to an electrochemical cell are described, for example, in U.S. Patent Publication No. 2010/0035128 to Scordilis-Kelley et al. filed on Aug. 4, 2009, entitled “Application of Force in Electrochemical Cells,” which is incorporated herein by reference in its entirety for all purposes.

In certain embodiments, pressure transmitter 116 is not substantially moveable relative to electrochemical cell 110, and a force can be applied to the electrochemical cell, for example, by pressurizing the pressure distributor 114. In some such embodiments, pressurizing the pressure distributor can result in the application of a force to the electrochemical cell because the substantially immovable pressure transmitter 116 restricts the movement of one or more of the boundaries of pressure distributor 114, thereby applying an anisotropic force to electrochemical cell 110.

In certain embodiments, pressure transmitter comprises all or part of a substantially rigid structure (e.g., a package enclosing an electrochemical cell), and the movement of the pressure transmitter can be restricted by the degree to which the substantially rigid structure is inflexible. In certain embodiments, the pressure transmitter can comprise a structure that is integrated with at least a portion of the other components of the system, which can restrict its movement. For example, in certain embodiments, the pressure transmitter can comprise at least a portion of one or more walls of a package within which electrochemical cell 110 and pressure distributor 114 are positioned. As one particular example, pressure transmitter 116 might form a first wall of a package containing electrochemical cell 110 while substrate 122 forms a second wall (e.g., opposite to the first wall) of the package. In certain embodiments, the movement of pressure transmitter 116 can be restricted by applying a force within and/or on the pressure transmitter such that its movement is restricted. In any of these cases, a force can be applied to the electrochemical cell, in certain embodiments, by adding fluid to and/or maintaining the amount of fluid within pressure distributor 114.

FIG. 1A illustrates a set of embodiments in which a single pressure transmitter and a single pressure distributor are used to apply a force to an electrochemical cell. In certain embodiments, however, more than one pressure distributor and/or more than one pressure transmitter can be employed. For example, in the set of embodiments illustrated in FIG. 1B, system 100 includes a second pressure distributor 114B positioned under electrochemical cell 110 and a second pressure transmitter 116B positioned under pressure distributor 114B. In certain embodiments, a substantially evenly distributed force can be applied to external surface 112B of electrochemical cell 110 through pressure distributor 114B, for example, by applying a force to and/or through pressure transmitter 116B and onto surface 120B of pressure distributor 114B.

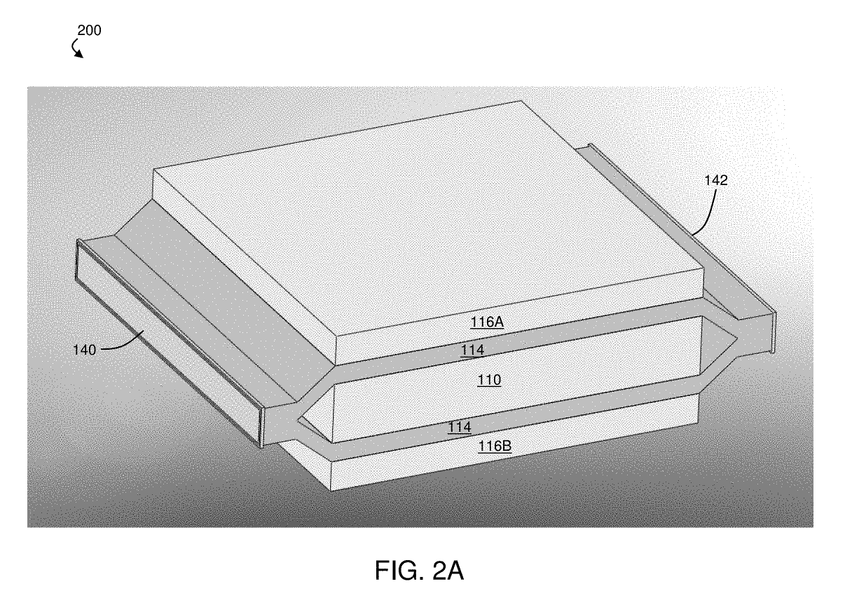

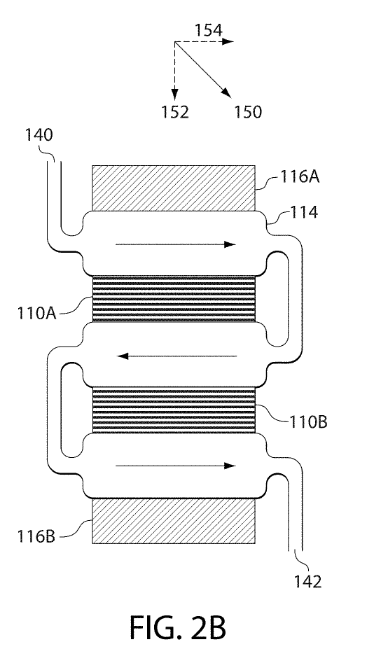

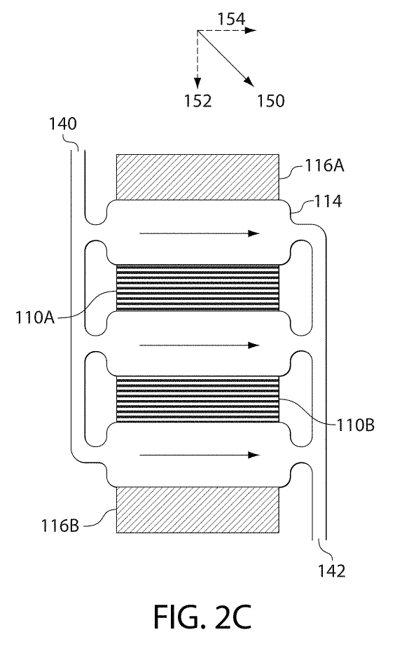

In some embodiments, fluid can be transported into and/or out of the pressure distributor to transport heat to and/or away from electrochemical cell 110. FIG. 2A is an exemplary schematic illustration of system 200 in which pressure distributor 114 includes an inlet 140 and an outlet 142 configured to transport a fluid through pressure distributor 114. As fluid is transported through pressure distributor 114, it can absorb heat from electrochemical cell 110 and transport it away from system 200 via outlet 142. Any suitable device can be used to transport the fluid through the pressure distributor such as, for example, a pump, a vacuum, or any other suitable device.

In certain embodiments, the fluid used in association with the pressure distributor can be selected such that it cools the system to a desired degree. For example, in certain embodiments, the fluid within the pressure distributor can comprise a coolant such as water, ethylene glycol, diethylene glycol, propylene glycol, polyalkylene glycols (PAGs), oils (e.g., mineral oils, castor oil, silicone oils, fluorocarbon oils, and/or refrigerants (e.g., freons, chlorofluorocarbons, perfluorocarbons, and the like).

The embodiments described herein can be used with a variety of electrochemical cells. While primary (disposable) electrochemical cells and secondary (rechargeable) electrochemical cells can be used in association with the embodiments described herein, some embodiments advantageously make use of secondary electrochemical cells, for example, due to the benefits provided by uniform force application during the (re)charging process. In certain embodiments, the electrochemical cell comprises a lithium-based electrochemical cell such as a lithium-sulfur electrochemical cell (and assemblies of multiple cells, such as batteries thereof).

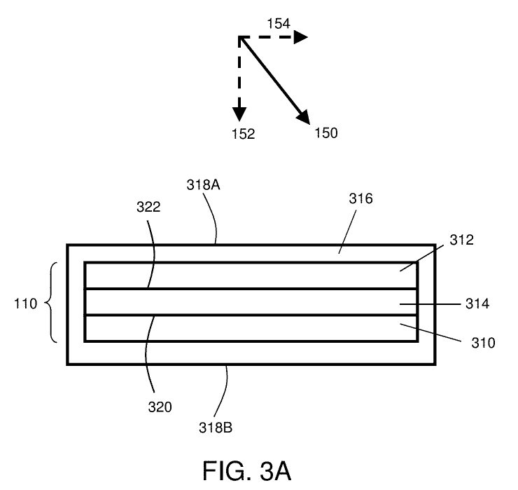

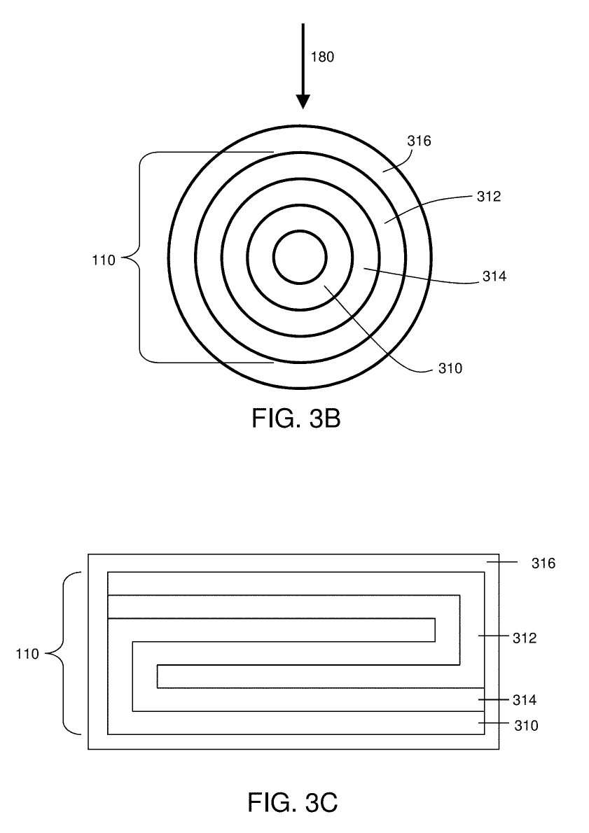

Although the present invention can find use in a wide variety of electrochemical devices, an example of one such device is provided in FIG. 3A for illustrative purposes only. In FIG. 3A, a general embodiment of electrochemical cell 110 includes cathode 310, anode 312, and electrolyte 314 in electrochemical communication with the cathode and the anode.

In some cases, electrochemical cell 110 may optionally be at least partially contained by containment structure 316. Containment structure 316 may comprise a variety of shapes including, but not limited to, cylinders, prisms (e.g., triangular prisms, rectangular prisms, etc.), cubes, or any other shape. In certain embodiments, a pressure distributor can be associated with electrochemical cell 110 by positioning the pressure distributor outside containment structure 316, in either direct or indirect contact with surface 318A and/or surface 318B. When positioned in this way, the pressure distributor can be configured to apply a force, directly or indirectly, to surfaces 318A and/or 318B of containment structure 316, as described above. In certain embodiments, a pressure distributor can be positioned between cathode 310 and containment structure 316, or between anode 312 and containment structure 316. In some such embodiments, containment structure can act as a pressure transmitter and/or a separate pressure transmitter can be configured to apply a force to the pressure distributor via the containment structure.

A typical electrochemical cell system also would include, of course, current collectors, external circuitry, and the like. Those of ordinary skill in the art are well aware of the many arrangements that can be utilized with the general schematic arrangement as shown in the figures and described herein.

The components of electrochemical cell 110 may be assembled, in some cases, such that the electrolyte is located between the cathode and the anode in a planar configuration. For example, in the embodiments illustrated in FIG. 3A, cathode 310 of electrochemical cell 110 is substantially planar. A substantially planar cathode can be formed, for example, by coating a cathode slurry on a planar substrate, such as a metal foil or other suitable substrate, which may be included in the assembly of electrochemical cell 110 (although not illustrated in FIG. 3A) or removed from cathode 310 prior to assembly of the electrochemical cell. In addition, in FIG. 3A, anode 312 is illustrated as being substantially planar. A substantially planar anode can be formed, for example, by forming a sheet of metallic lithium, by forming an anode slurry on a planar substrate, or by any other suitable method. Electrolyte 314 is also illustrated as being substantially planar in FIG. 3A.

In certain embodiments, electrochemical cell 110 can comprise an electrode that comprises a metal such as an elemental metal and/or a metal alloy. As one particular example, in certain embodiments, electrochemical cell 110 can comprise an anode comprising elemental lithium (e.g., elemental lithium metal and/or a lithium alloy). In certain embodiments, the anisotropic force applied to the electrochemical cell is sufficiently large such that the application of the force affects the surface morphology of the metal within an electrode of the electrochemical cell, as described in more detail below.

While FIG. 3A illustrates an electrochemical cell arranged in a planar configuration, it is to be understood that any electrochemical cell arrangement can be constructed, employing the principles of the present invention, in any configuration. For example, FIG. 3B is a cross-sectional schematic illustration of an electrochemical cell arranged as a cylinder. FIG. 3C is a cross-sectional schematic illustration of an electrochemical cell 110 comprising a folded multi-layer structure. In addition to the shapes illustrated in FIGS. 3A-3C, the electrochemical cells described herein may be of any other shape including, but not limited to, prisms (e.g., triangular prisms, rectangular prisms, etc.), “Swiss-rolls,” non-planar multi-layered structures, etc. Additional configurations are described in U.S. patent application Ser. No. 11/400,025, filed Apr. 6, 2006, entitled, “Electrode Protection in both Aqueous and Non-Aqueous Electrochemical Cells, including Rechargeable Lithium Batteries,” to Affinito et al., which is incorporated herein by reference in its entirety.

In some embodiments, the cathode and/or the anode comprise at least one active surface. As used herein, the term “active surface” is used to describe a surface of an electrode that is in physical contact with the electrolyte and at which electrochemical reactions may take place. For example, in the set of embodiments illustrated in FIG. 3A, cathode 310 includes cathode active surface 320 and anode 312 includes anode active surface 322.

In certain embodiments, the anisotropic force applied to pressure transmitter 116 and/or through pressure distributor 114 (and eventually in some cases to surface 112 of electrochemical cell 110) comprises a component normal to the active surface of an electrode (e.g., an anode such as an anode containing lithium metal) within the electrochemical cell. Accordingly, applying an anisotropic force through pressure distributor 114 to the electrochemical cell can result in an anisotropic force being applied to an active surface of an electrode (e.g., an anode) within the electrochemical cell. In the case of a planar electrode surface, the applied force may comprise an anisotropic force with a component normal to the electrode active surface at the point at which the force is applied. For example, referring back to the set of embodiments illustrated in FIG. 1A and FIG. 3A, an anisotropic force in the direction of arrow 150 may be applied to electrochemical cell 110 through pressure distributor 114. An anisotropic force applied in the direction of arrow 150 would include a component 152 that is normal to anode active surface 322 and normal to cathode active surface 320. In addition, an anisotropic force applied in the direction of arrow 150 would include a component 154 that is not normal (and is in fact parallel) to anode active surface 322 and cathode active surface 320.

In the case of a curved surface (e.g., a concave surface or a convex surface), the force applied to the electrochemical cell may comprise an anisotropic force with a component normal to a plane that is tangent to the curved surface at the point at which the force is applied. For example, referring to the cylindrical cell illustrated in FIG. 3B, a force may be applied to an external surface of the cell comprising a component oriented in the direction of arrow 180.

In one set of embodiments, systems and methods of the invention are configured such that, during at least one period of time during charge and/or discharge of the cell, an anisotropic force with a component normal to the active surface of an electrode (e.g., the anode) is applied to the electrochemical cell. In some embodiments, the force may be applied continuously, over one period of time, or over multiple periods of time that may vary in duration and/or frequency.

The magnitude of the applied force is, in some embodiments, large enough to enhance the performance of the electrochemical cell. In certain embodiments, an electrode active surface (e.g., an anode active surface) and the anisotropic force may be together selected such that the anisotropic force affects surface morphology of the electrode active surface to inhibit an increase in electrode active surface area through charge and discharge and wherein, in the absence of the anisotropic force but under otherwise essentially identical conditions, the electrode active surface area is increased to a greater extent through charge and discharge cycles. “Essentially identical conditions,” in this context, means conditions that are similar or identical other than the application and/or magnitude of the force. For example, otherwise identical conditions may mean a cell that is identical, but where it is not constructed (e.g., by brackets or other connections) to apply the anisotropic force on the subject electrochemical cell.

The electrode active surface and anisotropic force can be selected together, to achieve results described herein, easily by those of ordinary skill in the art. For example, where the electrode active surface is relatively soft, the component of the force normal to the electrode active surface may be selected to be lower. Where the electrode active surface is harder, the component of the force normal to the electrode active surface may be greater. Those of ordinary skill in the art, given the present disclosure, can easily select anode materials, alloys, mixtures, etc. with known or predictable properties, or readily test the hardness or softness of such surfaces, and readily select cell construction techniques and arrangements to provide appropriate forces to achieve what is described herein. Simple testing can be done, for example by arranging a series of active materials, each with a series of forces applied normal (or with a component normal) to the active surface, to determine the morphological effect of the force on the surface without cell cycling (for prediction of the selected combination during cell cycling) or with cell cycling with observation of a result relevant to the selection.

As noted above, in some embodiments, an anisotropic force with a component normal to an electrode active surface (e.g., of the anode) is applied, during at least one period of time during charge and/or discharge of the cell, to an extent effective to inhibit an increase in surface area of the electrode active surface relative to an increase in surface area absent the anisotropic force. The component of the anisotropic force normal to the electrode active surface may, for example, define a pressure of at least about 20, at least about 25, at least about 35, at least about 40, at least about 50, at least about 75, at least about 90, at least about 100, at least about 125 or at least about 150 Newtons per square centimeter. In certain embodiments, the component of the anisotropic force normal to the anode active surface may, for example, define a pressure of less than about 200, less than about 190, less than about 175, less than about 150, less than about 125, less than about 115, or less than about 110 Newtons per square centimeter. While forces and pressures are generally described herein in units of Newtons and Newtons per unit area, respectively, forces and pressures can also be expressed in units of kilograms-force and kilograms-force per unit area, respectively. One of ordinary skill in the art will be familiar with kilogram-force-based units, and will understand that 1 kilogram-force is equivalent to about 9.8 Newtons.

In certain embodiments, the component of the anisotropic force normal to the active surface of an electrode within the electrochemical cell defines a pressure that is at least about 50%, at least about 75%, at least about 100%, at least about 120% of the yield stress of that electrode (e.g., during charge and/or discharge of the electrochemical cell). In certain embodiments, the component of the anisotropic force normal to the active surface of an electrode within the electrochemical cell defines a pressure that is less than about 250% or less than about 200% of the yield stress of that electrode (e.g., during charge and/or discharge of the electrochemical cell). For example, in some embodiments, the electrochemical cell can comprise an anode (e.g., an anode comprising lithium metal and/or a lithium alloy), and the component of an applied anisotropic force that is normal to the anode active surface can define a pressure that is at least about 50%, at least about 75%, at least about 100%, or at least about 120% of the yield stress of the anode (and/or less than about 250% or less than about 200% of the yield stress of the anode). In some embodiments, the electrochemical cell can comprise a cathode, and the component of the anisotropic force normal to the cathode active surface can define a pressure that is at least about 50%, at least about 75%, at least about 100%, or at least about 120% of the yield stress of the cathode (and/or less than about 250% or less than about 200% of the yield stress of the cathode).

While the application of force to a single electrochemical cell has been primarily described, in certain embodiments, any of the forces described herein may be applied to a plurality of electrochemical cells in a stack. As used herein, a “stack” of electrochemical cells is used to refer to a configuration in which multiple cells are arranged in an essentially cell-repetitive pattern, e.g., positioned on top of one another. In some cases, the cells may be positioned such that at least one surface of each cell in the stack is substantially parallel to at least one surface of every other cell in the stack, e.g., where a surface of one particular component (e.g., the anode) of one cell is substantially parallel to the same surface of the same component of every other cell. For example, FIG. 1D includes a schematic illustration of a stack of electrochemical cells 110A and 110B. In this set of embodiments, pressure distributor 114B is positioned between electrochemical cells 110A and 110B, although in other embodiments, there is no pressure distributor between the stacked electrochemical cells (e.g., electrochemical cells 110A and 110B may be in direct contact with one another).

In certain embodiments, fluid is transported through one or more pressure distributors to transfer heat away from a stack of electrochemical cells. For example, FIG. 2B is a cross-sectional schematic illustration of a system in which heat is transported to and/or away from electrochemical cells 110A and 110B by transporting a fluid through pressure distributor 114. In the set embodiments illustrated in FIG. 2B, the fluid within pressure distributor 114 is transported between the electrochemical cells in a series arrangement (i.e., the fluid is first transported between electrochemical cell 110A and pressure transmitter 116A, then is transported between electrochemical cells 110A and 110B, and finally is transported between electrochemical cell 110B and pressure transmitter 116B). In other embodiments, including the embodiment illustrated in FIG. 2C, the fluid within pressure distributor 114 is transported between the electrochemical cells in a parallel arrangement (i.e., the fluid is first transported between electrochemical cell 110A and pressure transmitter 116A, between electrochemical cells 110A and 110B, and between electrochemical cell 110B and pressure transmitter 116B simultaneously).

While FIGS. 1D, 2B and 2C illustrate stacks with 2 electrochemical cells, it should be understood that a stack can include any suitable number of electrochemical cells. For example, in some cases, the stack of electrochemical cells may comprise 2 or more, 3 or more, 5 or more, 10 or more, 25 or more, or 100 or more electrochemical cells.

In some cases, the anisotropic force can define a pressure that is relatively uniform across one or more external surfaces of the electrochemical cell and/or across one or more active surfaces of electrode(s) within the electrochemical cell. In some embodiments, at least about 50%, at least about 75%, at least about 85%, at least about 90%, at least about 95%, or at least about 98% of the area of one or more external surfaces of an electrochemical cell and/or of the area of one or more active surfaces of an electrode (e.g., anode) defines a uniform area that includes a substantially uniform distribution of pressure defined by an anisotropic force. In this context, a “surface of an electrochemical cell” and a “surface of an electrode” refer to the geometric surfaces of the electrochemical cell and the electrode, which will be understood by those of ordinary skill in the art to refer to the surfaces defining the outer boundaries of the electrochemical cell and electrode, for example, the area that may be measured by a macroscopic measuring tool (e.g., a ruler) and does not include the internal surface area (e.g., area within pores of a porous material such as a foam, or surface area of those fibers of a mesh that are contained within the mesh and do not define the outer boundary, etc.).

In some embodiments, a pressure is substantially uniformly distributed across a surface when any continuous area that covers about 10%, about 5%, about 2%, or about 1% of the uniform area (described in the preceding paragraph) includes an average pressure that varies by less than about 25%, less than about 10%, less than about 5%, less than about 2%, or less than about 1% relative to the average pressure across the entirety of the uniform area.

Stated another way, in some embodiments, at least about 50% (or at least about 75%, at least about 85%, at least about 90%, at least about 95%, or at least about 98%) of the area of a surface of the electrochemical cell and/or of the active area of an electrode defines a first, continuous area of essentially uniform applied pressure, the first area having a first average applied pressure. In some cases, any continuous area that covers about 10% (or about 5%, about 2%, or about 1%) of the first, continuous area of the surface of the electrochemical cell and/or of the electrode includes a second average applied pressure that varies by less than about 25% (or less than about 10%, less than about 5%, less than about 2%, or less than about 1%) relative to the first average applied pressure across the first, continuous area.

One of ordinary skill in the art would be capable of determining an average applied pressure within a portion of a surface, for example, by determining the force level applied at a representative number of points within the surface portion, integrating a 3-dimensional plot of the applied pressure as a function of position on the surface portion, and dividing the integral by the surface area of the surface portion. One of ordinary skill in the art would be capable of producing a plot of the applied pressure across a surface portion by, for example, using a Tekscan I-Scan system for measuring the pressure field.

The anodes of the electrochemical cells described herein may comprise a variety of anode active materials. As used herein, the term “anode active material” refers to any electrochemically active species associated with the anode. For example, the anode may comprise a lithium-containing material, wherein lithium is the anode active material. Suitable electroactive materials for use as anode active materials in the anode of the electrochemical cells described herein include, but are not limited to, lithium metal such as lithium foil and lithium deposited onto a conductive substrate, and lithium alloys (e.g., lithium-aluminum alloys and lithium-tin alloys). Methods for depositing a negative electrode material (e.g., an alkali metal anode such as lithium) onto a substrate may include methods such as thermal evaporation, sputtering, jet vapor deposition, and laser ablation. Alternatively, where the anode comprises a lithium foil, or a lithium foil and a substrate, these can be laminated together by a lamination process as known in the art to form an anode.

In one embodiment, an electroactive lithium-containing material of an anode active layer comprises greater than 50% by weight of lithium. In another embodiment, the electroactive lithium-containing material of an anode active layer comprises greater than 75% by weight of lithium. In yet another embodiment, the electroactive lithium-containing material of an anode active layer comprises greater than 90% by weight of lithium. Additional materials and arrangements suitable for use in the anode are described, for example, in U.S. Patent Publication No. 2010/0035128 to Scordilis-Kelley et al. filed on Aug. 4, 2009, entitled “Application of Force in Electrochemical Cells,” which is incorporated herein by reference in its entirety for all purposes.

The cathodes in the electrochemical cells described herein may comprise a variety of cathode active materials. As used herein, the term “cathode active material” refers to any electrochemically active species associated with the cathode. Suitable electroactive materials for use as cathode active materials in the cathode of the electrochemical cells of the invention include, but are not limited to, electroactive transition metal chalcogenides, electroactive conductive polymers, sulfur, carbon and/or combinations thereof. As used herein, the term “chalcogenides” pertains to compounds that contain one or more of the elements of oxygen, sulfur, and selenium. Examples of suitable transition metal chalcogenides include, but are not limited to, the electroactive oxides, sulfides, and selenides of transition metals selected from the group consisting of Mn, V, Cr, Ti, Fe, Co, Ni, Cu, Y, Zr, Nb, Mo, Ru, Rh, Pd, Ag, Hf, Ta, W, Re, Os, and Ir. In one embodiment, the transition metal chalcogenide is selected from the group consisting of the electroactive oxides of nickel, manganese, cobalt, and vanadium, and the electroactive sulfides of iron. In one embodiment, a cathode includes one or more of the following materials: manganese dioxide, iodine, silver chromate, silver oxide and vanadium pentoxide, copper oxide, copper oxyphosphate, lead sulfide, copper sulfide, iron sulfide, lead bismuthate, bismuth trioxide, cobalt dioxide, copper chloride, manganese dioxide, and carbon. In another embodiment, the cathode active layer comprises an electroactive conductive polymer. Examples of suitable electroactive conductive polymers include, but are not limited to, electroactive and electronically conductive polymers selected from the group consisting of polypyrroles, polyanilines, polyphenylenes, polythiophenes, and polyacetylenes. Examples of conductive polymers include polypyrroles, polyanilines, and polyacetylenes.

In some embodiments, electroactive materials for use as cathode active materials in electrochemical cells described herein include electroactive sulfur-containing materials. “Electroactive sulfur-containing materials,” as used herein, relates to cathode active materials which comprise the element sulfur in any form, wherein the electrochemical activity involves the oxidation or reduction of sulfur atoms or moieties. The nature of the electroactive sulfur-containing materials useful in the practice of this invention may vary widely, as known in the art. For example, in one embodiment, the electroactive sulfur-containing material comprises elemental sulfur. In another embodiment, the electroactive sulfur-containing material comprises a mixture of elemental sulfur and a sulfur-containing polymer. Thus, suitable electroactive sulfur-containing materials may include, but are not limited to, elemental sulfur and organic materials comprising sulfur atoms and carbon atoms, which may or may not be polymeric. Suitable organic materials include those further comprising heteroatoms, conductive polymer segments, composites, and conductive polymers.

In some embodiments, an electroactive sulfur-containing material of a cathode active layer comprises greater than 50% by weight of sulfur. In another embodiment, the electroactive sulfur-containing material comprises greater than 75% by weight of sulfur. In yet another embodiment, the electroactive sulfur-containing material comprises greater than 90% by weight of sulfur.

The cathode active layers of the present invention may comprise from about 20 to 100% by weight of electroactive cathode materials (e.g., as measured after an appropriate amount of solvent has been removed from the cathode active layer and/or after the layer has been appropriately cured). In one embodiment, the amount of electroactive sulfur-containing material in the cathode active layer is in the range of 5-30% by weight of the cathode active layer. In another embodiment, the amount of electroactive sulfur-containing material in the cathode active layer is in the range of 20% to 90% by weight of the cathode active layer.

Additional materials suitable for use in the cathode, and suitable methods for making the cathodes, are described, for example, in U.S. Pat. No. 5,919,587, filed May 21, 1997, entitled “Novel Composite Cathodes, Electrochemical Cells Comprising Novel Composite Cathodes, and Processes for Fabricating Same,” and U.S. Patent Publication No. 2010/0035128 to Scordilis-Kelley et al. filed on Aug. 4, 2009, entitled “Application of Force in Electrochemical Cells,” each of which is incorporated herein by reference in its entirety for all purposes.

A variety of electrolytes can be used in association with the electrochemical cells described herein. In some embodiments, the electrolyte may comprise a non-solid electrolyte, which may or may not be incorporated with a porous separator. As used herein, the term “non-solid” is used to refer to materials that are unable to withstand a static shear stress, and when a shear stress is applied, the non-solid experiences a continuing and permanent distortion. Examples of non-solids include, for example, liquids, deformable gels, and the like.

The electrolytes used in electrochemical cells described herein can function as a medium for the storage and transport of ions, and in the special case of solid electrolytes and gel electrolytes, these materials may additionally function as a separator between the anode and the cathode. Any liquid, solid, or gel material capable of storing and transporting ions may be used, so long as the material facilitates the transport of ions (e.g., lithium ions) between the anode and the cathode. Exemplary materials suitable for use in the electrolyte are described, for example, in U.S. Patent Publication No. 2010/0035128 to Scordilis-Kelley et al. filed on Aug. 4, 2009, entitled “Application of Force in Electrochemical Cells,” which is incorporated herein by reference in its entirety for all purposes.

The following documents are incorporated herein by reference in their entireties for all purposes: U.S. Pat. No. 7,247,408, filed May 23, 2001, entitled “Lithium Anodes for Electrochemical Cells”; U.S. Pat. No. 5,648,187, filed Mar. 19, 1996, entitled “Stabilized Anode for Lithium-Polymer Batteries”; U.S. Pat. No. 5,961,672, filed Jul. 7, 1997, entitled “Stabilized Anode for Lithium-Polymer Batteries”; U.S. Pat. No. 5,919,587, filed May 21, 1997, entitled “Novel Composite Cathodes, Electrochemical Cells Comprising Novel Composite Cathodes, and Processes for Fabricating Same”; U.S. patent application Ser. No. 11/400,781, filed Apr. 6, 2006, published as U. S. Pub. No. 2007-0221265, and entitled “Rechargeable Lithium/Water, Lithium/Air Batteries”; International Patent Apl. Serial No.: PCT/US2008/009158, filed Jul. 29, 2008, published as International Pub. No. WO/2009017726, and entitled “Swelling Inhibition in Lithium Batteries”; U.S. patent application Ser. No. 12/312,764, filed May 26, 2009, published as U.S. Pub. No. 2010-0129699, and entitled “Separation of Electrolytes”; International Patent Apl. Serial No.: PCT/US2008/012042, filed Oct. 23, 2008, published as International Pub. No. WO/2009054987, and entitled “Primer for Battery Electrode”; U.S. patent application Ser. No. 12/069,335, filed Feb. 8, 2008, published as U.S. Pub. No. 2009-0200986, and entitled “Protective Circuit for Energy-Storage Device”; U.S. patent application Ser. No. 11/400,025, filed Apr. 6, 2006, published as U.S. Pub. No. 2007-0224502, and entitled “Electrode Protection in both Aqueous and Non-Aqueous Electrochemical Cells, including Rechargeable Lithium Batteries”; U.S. patent application Ser. No. 11/821,576, filed Jun. 22, 2007, published as U.S. Pub. No. 2008/0318128, and entitled “Lithium Alloy/Sulfur Batteries”; patent application Ser. No. 11/111,262, filed Apr. 20, 2005, published as U.S. Pub. No. 2006-0238203, and entitled “Lithium Sulfur Rechargeable Battery Fuel Gauge Systems and Methods”; U.S. patent application Ser. No. 11/728,197, filed Mar. 23, 2007, published as U.S. Pub. No. 2008-0187663, and entitled “Co-Flash Evaporation of Polymerizable Monomers and Non-Polymerizable Carrier Solvent/Salt Mixtures/Solutions”; International Patent Apl. Serial No.: PCT/US2008/010894, filed Sep. 19, 2008, published as International Pub. No. WO/2009042071, and entitled “Electrolyte Additives for Lithium Batteries and Related Methods”; International Patent Apl. Serial No.: PCT/US2009/000090, filed Jan. 8, 2009, published as International Pub. No. WO/2009/089018, and entitled “Porous Electrodes and Associated Methods”; U.S. patent application Ser. No. 12/535,328, filed Aug. 4, 2009, published as U.S. Pub. No. 2010/0035128, and entitled “Application of Force In Electrochemical Cells”; U.S. patent application Ser. No. 12/727,862, filed Mar. 19, 2010, entitled “Cathode for Lithium Battery”; U.S. patent application Ser. No. 12/471,095, filed May 22, 2009, entitled “Hermetic Sample Holder and Method for Performing Microanalysis Under Controlled Atmosphere Environment”; U.S. patent application Ser. No. 12/862,513, filed on Aug. 24, 2010, entitled “Release System for Electrochemical cells (which claims priority to Provisional Patent Apl. Ser. No. 61/236,322, filed Aug. 24, 2009, entitled “Release System for Electrochemical Cells”); U.S. Provisional Patent Apl. Ser. No. 61/376,554, filed on Aug. 24, 2010, entitled “Electrically Non-Conductive Materials for Electrochemical Cells;” U.S. Provisional patent application Ser. No. 12/862,528, filed on Aug. 24, 2010, entitled “Electrochemical Cell;” U.S. patent application Ser. No. 12/862,563, filed on Aug. 24, 2010, published as U.S. Pub. No. 2011/0070494, entitled “Electrochemical Cells Comprising Porous Structures Comprising Sulfur” [51583.70029US00]; U.S. patent application Ser. No. 12/862,551, filed on Aug. 24, 2010, published as U.S. Pub. No. 2011/0070491, entitled “Electrochemical Cells Comprising Porous Structures Comprising Sulfur” [51583.70030US00]; U.S. patent application Ser. No. 12/862,576, filed on Aug. 24, 2010, published as U.S. Pub. No. 2011/0059361, entitled “Electrochemical Cells Comprising Porous Structures Comprising Sulfur” [51583.70031US00]; U.S. patent application Ser. No. 12/862,581, filed on Aug. 24, 2010, published as U.S. Pub. No. 2011/0076560, entitled “Electrochemical Cells Comprising Porous Structures Comprising Sulfur” [51583.70024US01]; U.S. Patent Apl. Ser. No. 61/385,343, filed on Sep. 22, 2010, entitled “Low Electrolyte Electrochemical Cells” [51583.70033US00]; and U.S. patent application Ser. No. 13/033,419, filed Feb. 23, 2011, entitled “Porous Structures for Energy Storage Devices” [51583.70034US00]. All other patents and patent applications disclosed herein are also incorporated by reference in their entirety for all purposes.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1-31. (canceled)

32. A method, comprising:
transporting a fluid into an inlet of a container, through the container, and out of an outlet of the container, wherein the container is located between an electrochemical cell and a pressure transmitter configured to apply an anisotropic force to at least one component of the electrochemical cell.

33. The method of claim 32, wherein transporting the fluid through the container removes heat from the electrochemical cell.

34. The method of claim 32, wherein:
the container has an external surface, and
the pressure transmitter is configured to apply an anisotropic force to the external surface of the container, resulting in transmission of the anisotropic force from the external surface of the container, through the fluid in the container, and to at least one component of the electrochemical cell.

35. The method of claim 32, wherein the anisotropic force is applied to an internal surface of the container.

36. The method of claim 37, wherein the anisotropic force is applied to an internal surface of the container by pressurizing the fluid within the container.

37. The method of claim 32, wherein the fluid comprises a gas.

38. The method of claim 32, wherein the fluid comprises a liquid.

39. The method of claim 32, wherein at least a portion of an external surface of the container faces an external surface of the electrochemical cell.

40. The method of claim 32, wherein the electrochemical cell comprises an electrode comprising an electrode active material comprising lithium.

41. The method of claim 40, wherein the lithium comprises lithium metal and/or a lithium alloy.

42. The method of claim 32, wherein the anisotropic force comprises a component normal to an active surface of an electrode within the electrochemical cell.

43. The method of claim 42, wherein the component of the anisotropic force defines a pressure of at least 20 Newtons per square cm.

44. The method of claim 32, wherein the container is moveable relative to the electrochemical cell.

45. The method of claim 32, wherein the container is not substantially moveable relative to the electrochemical cell.

46. The method of claim 32, wherein the container is in direct contact with the electrochemical cell.

47. The method of claim 32, wherein the container is flexible.

48. The method of claim 32, wherein the container comprises a polymer.

49. The method of claim 32, wherein the container is elastic.

50. A method, comprising:
transporting a fluid into an inlet of a container, through the container, and out of an outlet of the container, wherein:
the container has an external surface,
the container is located between an electrochemical cell and a location at which a force is applied to the external surface of the container, and
the force that is applied to the external surface of the container results in an anisotropic force being transmitted from the external surface of the container, through the fluid in the container, and to at least one component of the electrochemical cell.

51. An electrochemical system, comprising:
an electrochemical cell comprising an electrode;
a container containing a fluid; and
a pressure transmitter positioned to apply an anisotropic force to an external surface of the container, through the fluid in the container, and to at least one component of the electrochemical cell,
wherein:
at least a portion of the fluid is positioned between a location at which the anisotropic force is applied to the external surface of the container and the electrochemical cell, and
the container is fluidically connected to a device constructed to transport the fluid through the container.
